(19) United States
(12) Patent Application Publication
(10) Pub. No.: US 2008/0052531 A1
(43) Pub. Date: Feb. 28, 2008

(54) Device and Method for Secure Biometric Applications

(75) Inventors: Roy Lennart Martinsson, Vastra Frolunda (SE); Fredrik Tord Stadler, Bjarnum (SE); George Junzhuo Young, Croydon (AU)

Correspondence Address: FITCH EVEN TABIN AND FLANNERY, 120 SOUTH LA SALLE STREET, SUITE 1600, CHICAGO, IL, 60603-3406, US

(73) Assignee: ID-Catch AB, Lund (SE)

(21) Appl. No.: 11/463,936

(22) Filed: Aug. 11, 2006

(51) Int. Cl. H04L 9/00; G06F 12/14; H04K 1/00; H04L 9/32; G06F 11/30

(52) U.S. Cl. 713/189; 713/168; 380/270

(57) ABSTRACT

A data encryption device comprising a first and a second port adapted to communicate data from at least one external unit, an encryption unit connected to the first port, an internal memory connected to the encryption unit, a decryption unit connected to the internal memory and to the second port, and an authentication unit connected to the encryption unit and the decryption unit. The authentication is adapted to provide an authentication signal in response to a valid authentication of a user. The encryption unit is adapted to receive an authentication signal from the authentication unit and in response to a receipt of the authentication signal encrypt data received from the first port and transfer the encrypted data to the internal memory. The decryption unit is adapted to receive an authentication signal from the authentication unit and in response to a receipt of the authentication signal decrypt data received from the internal memory and transfer the decrypted data to the second port. A system in which the invention is implemented is also disclosed.

### TECHNICAL FIELD

The present invention relates generally to a device for providing secure data management, and more particularly to an authentication controlled encryption device which receives an authorization input from a user in order to perform encryption or decryption on data being input or output to the device.

### BACKGROUND OF THE INVENTION

Sharing of content, especially digital content such as media files is increasing in popularity in the connected society of today. Sharing of content is enabled in any system where users of the system can access a content, such as in a data network, a telecommunications network, a home entertainment system or over the Internet. The content can be provided by a user who wants to share it with other users. However, sometimes it is desirable to protect the content in question. Limiting access to a content is commonly carried out by means of encryption. For instance, a content encrypted by one user may be decrypted by other users, provided they have a key for decryption.

There are a lot of encryption systems on the worldwide market and many of them run as applications on computer platforms.

With software solutions there is always a risk that intruders can hack these systems. All information stored in software based systems such as on a hard disk can be hacked.

There are systems that take care of these problems, but they are built up with several active components needed to achieve secure communication between the components. These solutions are expensive and there are ways for hacking into also these solutions.

One of the more serious security hassles is the enormous amount of insecure USB-memories floating around on the world market. They pose a threat to the information that people want to keep protected, but are at the same time very convenient for portable storage of information. In comparison to distributed compact discs, the information can easily be changed, such as before a conference. In this case for instance, the USB-memories are more flexible because the information can always be changed.

There exists a various kinds of solutions for encrypting and decrypting information. For instance, a software application comprising encryption algorithms may be installed on a computer and then used to encrypt a data file upon request from a user. However, by using a software based solution, the user must have access to the software, for instance by installing it to begin with. Furthermore, encryption software are usually resource demanding, increasing the load on a processor and memory of a terminal or server. Also, in the process of installing something on a device such as a computer, it can be difficult to ensure that the device is perfectly clean from viruses or other potentially harmful codes of software residing in the memory of the device. Further, software based encryption solutions are not perfectly secure in that total control of the device the software is installed on is difficult, if not to say impossible to achieve. The device can for instance itself have been hi-jacked by ill willing hackers.

Hence there is a need to enhance the encryption of data, especially with respect to portable devices such as USB memories.

Furthermore, there are various applications that could benefit from improved security in data transfer. One such example is related to the field of restricting individuals access to content, but also to environments such as data management systems. Secure access control is also relevant for restricting access to certain designated places or areas, such as in buildings for instance. In such areas, it is common to use keys, codes or identification cards. However, a compromise is often made between security and convenience. Access systems can be quite complex, especially in environments with many users and many access areas and with a high level of individualization of each individual's access. Hence, also within the field of identification and access management it is desired to develop secure and convenient ways to allow users access to designated areas.

Other examples where it is requested provision for improved privacy and security in connection with communicating a data content are Internet Protocol (IP) based voice and video telephony.

### SUMMARY OF THE INVENTION

In view of the above, an object of the present invention is to solve or at least reduce the problems discussed above. One object is to provide an improved system for access control of environments. In particular, an object is to provide an improved management and sharing system for controlling access to a content.

The above objects, are obtained according to a first aspect of the present invention by a data encryption device comprising:

a first and a second port adapted to communicate data from at least one external unit,

an encryption unit connected to the first port,

an internal memory connected to the encryption unit,

a decryption unit connected to the internal memory and to the second port, and

an authentication unit connected to the encryption unit and the decryption unit. The authentication is adapted to provide an authentication signal in response to a valid authentication of a user. The encryption unit is adapted to receive an authentication signal from the authentication unit and in response to a receipt of the authentication signal encrypt data received from the first port and transfer the encrypted data to the internal memory. The decryption unit is adapted to receive an authentication signal from the authentication unit and in response to a receipt of the authentication signal decrypt data received from the internal memory and transfer the decrypted data to the second port.

As an advantage, control of the encryption or decryption process is improved. Information of the encryption process is kept within the device and hence, protected from being revealed, accessed or manipulated with. Also, by having a memory for storing of the encrypted data integrated in the device, the data does not have to be stored on any other device, an advantage especially when wanting to access a content in various locations on various terminals. It also has the advantage of not leaving any data, encrypted or decrypted, on any device, which data could be subjected to accessing attempts.

The above objects, are obtained according to a second aspect of the present invention, closely related to the first aspect of the invention, by a data encryption device comprising:

a first and a second port adapted to communicate data from at least one external unit,

an encryption unit connected to the first port and the second port,

a decryption unit connected to the first port and the second port, and

an authentication unit connected to the encryption unit and the decryption unit. The authentication unit is adapted to provide an authentication signal in response to a valid authentication of a user. The encryption unit is adapted to receive an authentication signal from the authentication unit and in response to a receipt of the authentication signal encrypt data received from the first port and transfer the encrypted data to the second port. The decryption unit is adapted to receive an authentication signal from the authentication unit and in response to a receipt of the authentication signal decrypt data received from the second port and transfer the encrypted data to the first port.

For instance, the encryption device can handle incoming encryption data or by its own encryption software, control and encrypt data to a secondary device such as a hard disk drive, NAND-flash, SD-memories, SIM-encryption device memories or equivalent encryption devices.

Transfer of data to or from the encryption controlled device is controlled by authorization using biometric input.

As an advantage, this makes it a very cost effective solution ensuring that all data shared with other devices is controlled and secured by the encryption device.

Furthermore, by for instance adding a female USB-contact and a USB host function to the device, content on any kind of USB mass storage device can be secured with the encryption device.

The secure encryption device can be used to encrypt any kind of data, also voice communications such as Internet Protocol, (IP)-telephony. Advantageously, people can communicate in a secure fashion, regardless of location and regardless of means for transmittal, wire or wireless.

It is also within the inventive idea to have a single device arranged to perform any of the previously mentioned aspects of the invention, or possible a combination thereof.

The encryption device according to the second aspect of the present invention may incorporate any features of the encryption device according to the first aspect of the present invention.

The above objects, are obtained according to a third aspect of the present invention, closely related to the first and second aspects of the invention, by a system comprising a data encryption device according to the second aspect and wherein the second port is further connected to an external unit. As an advantage, the device can act as an intermediate encryption device between for instance a computer and a storage medium such as a SIM card, a hard drive or a server.

Furthermore, according to one embodiment the system can also be arranged to hold at least a first key of at least a first key-pair, and the external device be arranged to hold at least a second key of the first key-pair. Hereby, the device can be used to give a user access to protected environments, such as buildings or other designated areas. Holding a plurality of keys, a single device can give access to a plurality of protected environments. Furthermore, a number of users can use the device, each user with access to an individual set of keys. As an advantage, each user has an individual combination of access rights to any protected environment. Administration of each individual's access rights to any number of restricted areas is also made more convenient.

According to yet a further embodiment of the present invention, the system may further comprise an external device, which external device comprises control means for controlling access to a designated area. The control means may for instance control the locking mechanism of a door such as to allow passage for a user having an encryption device and which encryption device is utilized to successfully authenticate the user's allowance to the restricted area.

According to one specific embodiment, the device may comprise host capabilities and be capable of connecting to other devices such as a USB memory, flash etc. Hereby, as an advantage, it is possible to have keys securely stored with encryption on external memories, and the device used as an encryption/decryption. The security of the system is inherent in that the encryption and decryption algorithm advantageously is integrated in the device so that it can not be manipulated with or accessed.

Furthermore, the encryption and decryption units may preferably be comprised within a single unit, hence, enabling a more compact arrangement of the individual components and thereby also resulting in smaller external measurements of the device itself. The internal data transmission may also be improved.

Furthermore, according to preferred embodiments for any of the preceding aspects, the encryption unit is adapted to encrypt received data internally of the encryption device. With internally, it is to be understood that the encryption unit constitutes a physical part of the encryption device. The encryption and decryption units may be arranged on a common chip of the encryption device. According to one embodiment, the encryption device comprises a single chip with at least one microprocessor for performing encryption and, preferably also decryption. The encryption and decryption units may also comprise an integrated part of the encryption device, such as in a single chip. Processing means for the authentication unit may also be integrated with the chip in order to provide for a compact and secure, self-contained circuit. Further, the memory may also be comprised internally in the single chip.

The authentication unit may further comprise a biometric sensor. As an advantage, individual authorization of a user is determined based on user specific characteristics. Hereby, the security of the device may be improved. As another embodiment, the device may be arranged to recognize a number of predetermined users, for instance by using biometric authorization. As a further embodiment, each individual user with authorization to use the device may have associated an individual set of predetermined operations. As an advantage, the rights for each user of a device according to the invention may be individually set for instance with regards to access rights to a specific content encrypted by the device.

The biometric sensor may be adapted to recognize a user's voice, finger print, retina, iris, ear acoustics, or any combinations thereof.

According to one embodiment of the invention, the external unit may comprise a computing device, a terminal, a server, a remote storage, a hard drive storage, a flash memory, or any combinations thereof.

According to a further embodiment according to the invention, the first and second ports may preferably comprise wireless connections.

According to another embodiment of the invention, the first and second port are one and the same port. Hence, encrypted or decrypted data may be transmitted on the same port in any direction. As an advantage, the number of ports can be held at a minimum.

According to yet another embodiment of the invention, the device may further comprise a switching device for determining whether the data received from the first port comprises encrypted or decrypted information. The switching device is further arranged to direct the received data to the encryption unit or decryption unit. Hence, as an advantage, only limited or none user interaction is needed for the data to be correctly processed. For instance, the switch may be implemented as a physical switch such as a lever or an activation button for user control, however the switching device may also be integrated internally in the encryption device and arranged to recognize the format of the data as received on a port and in response hereto transfer the data to the appropriate encryption or decryption unit.

According to still another embodiment of the invention, the determining is provided by recognizing information in a header of the received data, by receiving an indication induced by a user acting on a physical switch in connection with the encryption device or in response to a command provided by the user.

The encryption device according to the third aspect of the present invention may incorporate any features of the encryption device according to the first aspect or any features of the system according to the second aspect of the present invention.

The above objects, are obtained according to a fourth aspect of the present invention by a method for data encryption in an encryption device, the method comprising

receiving an authentication signal from an authentication unit;

encrypting data received from a first port of the device; and

transferring the encrypted data to a memory of the device.

The encryption device according to the fourth aspect of the present invention may incorporate any features of the encryption device according to the first aspect or any features of the system according to the second aspect of the present invention.

The above objects, are obtained according to a fifth aspect of the present invention by a method for data encryption in an encryption device, the method comprising

receiving an authentication signal from an authentication unit;

encrypting data received from a first port of the device; and

transferring the encrypted data to a second port of the device.

Furthermore, according to preferred embodiments for any of the preceding aspects, the encryption unit is adapted to encrypt received data internally of the encryption device.

In other words, the encryption device handles sensitive data and the protection thereof.

The encryption device can handle incoming encryption data and using its own encryption software control encrypt/decrypt data to and from a secondary device such as a hard disk drive, NAND-flash, SD-memories, SIM-encryption device memories or equivalent encryption devices or devices.

According to one embodiment, no data can be moved to or from the encryption device without a biometrically authorized person's biometric input. This makes a very cost effective solution to ensure that all data is securely stored on devices controlled by the secure encryption device.

According to a further embodiment of any aspect of the present invention, the device is further arranged to hold authentication information of at least a first and a second user. Hence, multiple users can use one encryption device. Each user has associated with him or her a predetermined level or extent of authority. For instance, a user may be authorized to encrypt or decrypt files internally stored on the device, but not information stored on external sources. In another example, the user may receive incoming encrypted voice communication, but is not allowed to initiate outgoing encrypted voice communication. In a case where an encryption device is used by multiple users, for instance to log on to another device, the device may hold information as to what the user may log on to. In another case, the device may hold information as to what sections of a building or environment a user is allowed access, for instance by having the device holding a number of keys to a number of doors or entrances. In this way, controlling access to a secure area is made easier. It is also convenient to administer the access rights. The device may also comprise different encryption algorithms for different users. Upon valid authorization, each user is then only allowed access to content which have been encrypted with the encryption algorithm that user is allowed to use.

The encryption device can also control data communication in enterprise systems, such as servers, by leaving a one time encrypted key to the system. The system will for instance recognize the encryption device and an authorized user using the device. Only after successful authorization of the user and successful recognition of the device data is allowed to be accessed from the system. Sensitive data is transferred to the device only when the encryption device has authorized the person using it. The same will happen when a user wants to send data to an enterprise system.

According to one further embodiment, the device may for instance be connected to the system via a terminal. The system according to the third aspect of the invention may further comprise a separate administration device for secure administration and configuration of the device. In this way, full control over the device is achieved since no access is allowed from external devices other than devices especially intended, and configured therefore, for purposes of editing user access rights controlled by the encryption device.

The encryption device will also make it possible to transfer bundled software to different environments under control of the biometrics. By authorizing, the user opens up the device and the secure encryption device will control the download process of the programs stored on the device.

This can be used for encryption purposes in e.g. a web-based encryption to secure e-mail between different people in an enterprise environment world wide.

The encryption device is arranged to control various electronic computer peripherals and devices, especially biometric sensors of various types. The device encrypts data, both files and communication. The device may comprise an encryption processor and memory for secure storing of crucial data and software. Hereby, full data integrity and security is achieved. According to one embodiment, the device is comprised on one single chip, which allows for the highest integrity of the components in its concealed environment.

The encryption device may comprise a special sensor interface that makes it possible to communicate with nearly all existing biometric sensors on the market, without any interface where the biometric result can be detected.

The encryption device can handle different kind of communications depending on what kind of peripherals are needed such as USB 1.1, USB 2.0, SPI bus communications, serial communication RS 232, AT/IDE, SD-Flash or NAND-Flash.

The present invention solves the aforementioned problems with security by having encryption algorithms placed inside the secure encryption device.

The biometric sensor, recorder or other devices for controlling authentication are all inside the secure encryption device.

One of the advantages with this technology is the provision of a total secure “platform” with built in encryption. If needed, the encryption device can contain several encryption algorithms,

Because of the solution with everything controlled in one encryption device the cost for this solution can be reduced.

The device may also be used to gain total control of a computer, ensuring full security. For instance, a software code, such as an operating system, for controlling the operations of a terminal may be stored on the encryption device's memory or an external memory connected to the encryption device. Since access to the memory is only gained through valid authorization, total control over the booting process of a computer may be achieved. By gaining control over the booting process, control is also gained over the entire operation of the computer.

Furthermore, an authorized person may have to enter a personal code which is combined with the result of the first authorized enrolled biometric data. The code may also be created together with a SIM circuit that can be changed for different users together with an algorithm which creates a unique identity number that will be used in different ways for addressing encryption devices in different environments.

Furthermore, by using the encryption device in combination with an external memory storage, such as a SIM, or SD-card, one decryption device can be used in combination with a number of different external memories. The user can choose the level of security on each encryption device knowing that no one can access the information stored.

The use of this device makes it possible to store an unlimited amount of information with the possibility to choose between different storage sizes for each need. This solution makes it possible for a user to have an optimized secure device with biometric security for a large amount of memories.

By further combining the encryption device with a SIM card reader, the device can be personalized so that for instance the security management on enterprise level can control all devices such that they can be used by different users depending the management decisions.

The SIM functionality makes this memory a replacement for other existing log on devices in for instance banking environments or other high security installations using SIM card technology.

This solution replaces other existing SIM-Card readers and can also use the existing SIM-Cards in these devices.

The combination of the security encryption device and a SIM-Card memory encryption device makes it possible to generate an existing SIM-code in the security encryption device when an authorization is demanded from the controlled computer, system or a program.

The security encryption device reads a public key in the SIM-encryption device and then, together with an authorized biometric input, a software in the secure CPU will make a calculation with these two inputs and then generate the wanted code encrypted to the system management. As an advantage, it is hereby achieved a tamperproof way of handling the code and password for various systems.

In further combination with an RFID tag, the encryption device can also be used for access control in security systems.

For high security use, a SIM-encryption device can be used to secure the device for a certain user as long as he or she will need this security for a special mission. As soon as the mission ends, then the SIM-Card can be replaced or the device can be stored, waiting for a new user.

This functionality makes it possible to bring down the amount of USB memory devices in an enterprise.

As soon as the secure encryption device is connected it can, on request from a monitoring system, control all communication with the device.

If a user wants to download information to a memory connected to the encryption device, all information that needs to be controlled during download will be verified by requiring for device biometric logon from the user. Upon valid authorization, download or transfer of data from the encryption device to a server of the system can take place.

As soon as a SIM card is disconnected, access to the data held in an enterprise system is lost and new authorization is needed. Access to a system can also be time dependent, and subject to predetermined time durations after which renewed authorization is needed to regain access to the system.

With the possibility of having exchangeable memories connected to a encryption device, it can be convenient to use for a lawyer or doctor for storing different cases, journals, on separate memories. As an advantage, it is cheaper than to use for instance common, unsecured USB memory sticks.

The security device can communicate with all systems that can handle a mass storage device functionality, but in some installations a PC is needed to administrate the user.

Various other embodiments according to the invention are especially suitable for implementation in a USB device. For instance, an encryption device integrated with a USB memory may be especially advantageous in combination with an SD-flash memory and a SIM-card. Another advantageous embodiment of the present invention is a USB-memory with host functionality for encryption of other USB devices. A further especially advantageous embodiment is a USB-memory for encryption of IP-telephone conversations.

Furthermore, the encryption device according to one embodiment is also well suited for controlling data communication in enterprise systems. For instance, a time encrypted key can be stored on a server of the enterprise system. The system will then recognize and allow access by the corresponding encryption device upon valid authorization by a user. After successful authorization, a data is allowed to be transferred between the device and the server of the enterprise system.

The encryption device can also be used to transfer bundled software between different environments. Upon successful authorization by a user, the encryption device can be used to control the download process of programs stored on the device.

The encryption device can also be used for web-based encryption for secure e-mail transfer between different people.

When using a device according to the invention for encryption of voice communication, a one time key may be generated and exchanged over a network, such as the Internet, before an encrypted conversation will be possible. The device may be connected to a communication network. When making or receiving a call, authorization is needed. Successful authorization initiates the encryption and decryption process of incoming and outgoing data communication respectively.

According to a further embodiment according to any aspect of the present invention, the device may also be used for providing encryption and/or decryption of video sequences. Hence, video over IP is provided in a private and secure manner.

The wording IP telephony is to be construed as routing of voice or video conversations over the Internet or through any other Internet Protocol (IP) based network comprising Voice over Internet Protocol (VoIP), Internet telephony, and Broadband Phone.

For convenient connection to a terminal connected to a network, the device may comprise host functionality and software to handle digitalized speech.

According to one embodiment, the voice encryption devise is applied between a USB telephone and a USB host connector in a terminal such as a stationary PC or laptop.

A software in either the terminal or the encryption device controls the voice conversation and enables storing of the conversation if wanted.

The authorized user of the encryption device can choose between storing the conversation encrypted in the PC or decrypted in a memory of the device. The conversation is preferably stored in a compressed multimedia format such as mp3, wma, or the alike to minimize memory usage.

Advantageously, the encryption device provides secure communication of both documents and voice conversations.

The biometric authentication process is realized by obtaining biometric characteristics from the person in question. The biometric data may be provided through the use of finger prints, voice recognition, retinal scan, etc.

The encryption device may also be integrated in a mobile phone. Hence, as an advantage, the number of items a user needs to carry is restricted and with the functionality of the invention integrated in a mobile phone, a user can instantly encrypt or decrypt data, i.e. data transferred to the mobile phone or even voice communication.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

### FIGURES

FIG. 1 shows conceptually a view of a data encryption device according to a first embodiment of the present invention;

FIG. 2 shows conceptually a view of a data encryption device according to a second embodiment of the present invention;

FIG. 3 shows conceptually a view of a system with a data encryption device according to the second embodiment of the present invention;

FIG. 4 shows a flow chart diagram over the steps of a method according to the present invention;

FIG. 5 shows conceptually a view of a system with a data encryption device and control means according to one embodiment of a third aspect of the present invention;

FIG. 6 shows conceptually a view of a system with a data encryption device and an administration device according to one embodiment of the present invention.

### DETAILED DESCRIPTION OF THE INVENTION

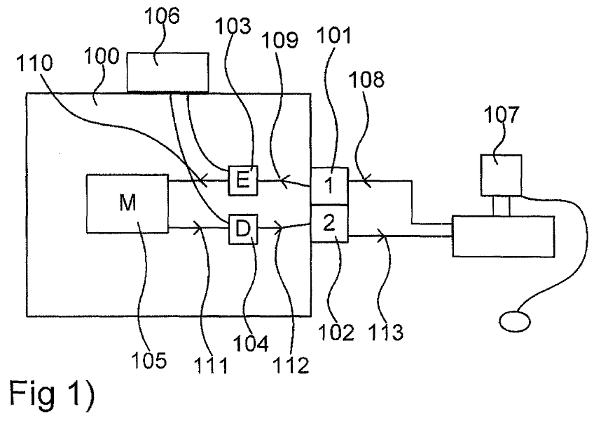

FIG. 1 shows a data encryption device 100 comprising a first 101 and a second port 102, an encryption unit 103, a decryption unit 104, an internal memory 105, an authentication unit 106 and an external unit 107. The first 101 and second ports 102 are adapted to communicate data (not shown) from at least one external unit 107. The encryption and decryption units are connected to the first port 101 and the second port 102, and the authentication unit 106 is connected to the encryption 103 and decryption 104 units. Not shown are wiring or other means for connecting the respective components. Arrows 108, 109, 110, 111, 112, and 113 indicate direction of data transfer. Arrows 108, 109, and 112 indicate transmission of non-encrypted data and arrows 111, 112, and 113 indicates transmission of encrypted data.

According to a first embodiment of the present invention, the data encryption device according to FIG. 1 is arranged to receive an input signal on its first port. In response to a valid authentication received from the authentication unit, the encryption unit encrypts the data received on the first port and transmits it to the internal memory. At any given time after that, the data encryption device may receive a request to retrieve the data previously encrypted and stored in its internal memory. Upon such a request, preferably from a user via the external device, the device retrieves the data from its memory, decrypts the data and outputs it on the second port, wherefrom it is transmitted to the external device and perhaps displayed on a screen or provided to the user in any other preferred way.

According to a specific example a user is for instance editing a document on a computer and wants to store the file securely on a portable device. The user connects the data encryption device to a port of the computer whereby an icon appears on the desktop as shown on a screen connected to the computer. The user drags the file to the icon representing the data encryption device and instantly, a request pops up on the screen requesting the user to authorize himself. The user applies a finger to a place on the encryption device for authentication whereby the authentication unit performs the authentication. Upon accepted authorization, the file is encrypted by the encryption unit of the data encryption device and subsequently transmitted to the internal memory where it is stored. The user receives an indication that the encryption process is completed and continues to work with the file or closes it. The user is careful not to save any non-encrypted version of the file on the computer. A copy of the encrypted file or the encrypted file itself may be transferred to the computer.

According to an alternative procedure, a user of the device editing a document on a terminal connected to the device can encrypt the document by moving an icon of the written document into a window, representing the encryption device. To indicate that the document has been successfully encrypted, an icon of the document appears in a window for encrypted documents. When the user wants to access the encrypted document for sending it in an e-mail for instance, he attaches the file, preferably by dragging the icon from the encryption window. If the user wants to decrypt a document, the process is simply reversed.

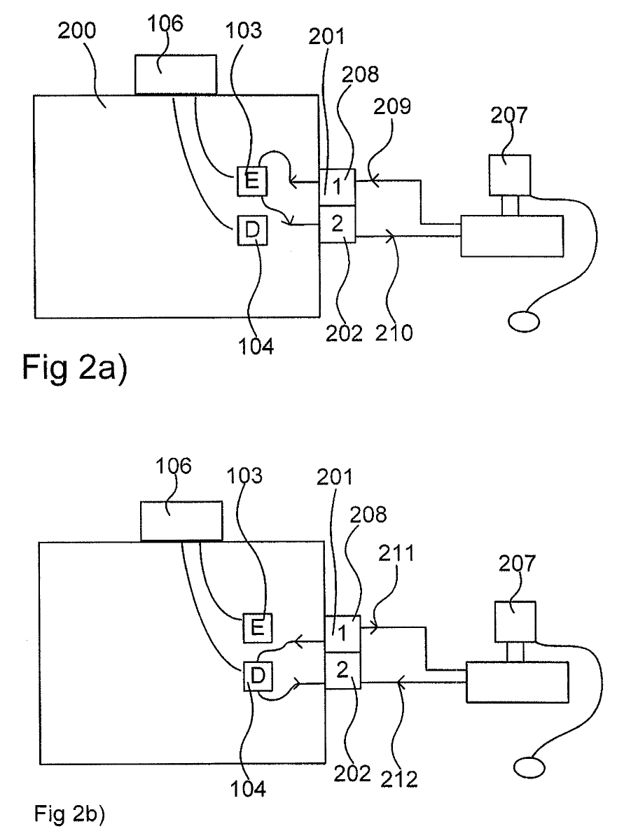

Sections a) and b) of FIG. 2 shows a data encryption device 200 similar to that shown in FIG. 1, but without the internal memory 105. The data encryption device comprises a connector 208 having a first 201 and a second port 202. The data encryption device may act as an on-the-fly encryption device for encrypting a file received from an external device 207 and return it to the external device. For instance, a file is received on the first port. The file is encrypted and transmitted to the second port, and further on to the external device where it is stored or further processed. Arrows 209, 210, 211 and 212 indicate direction of data transfer. Arrows 209 and 211 indicates transmission of non-encrypted data. Arrows 210 and 212 indicates transmission of encrypted data.

The encryption device according to FIG. 2 may also be used to encrypt and decrypt data for voice or video communications, such as IP-telephony. Hence, the encryption device can be connected to a computer comprising software for IP-communication, the computer being connected to a network, such as the Internet, and further comprising a user interface for audio and/or visual in and output.

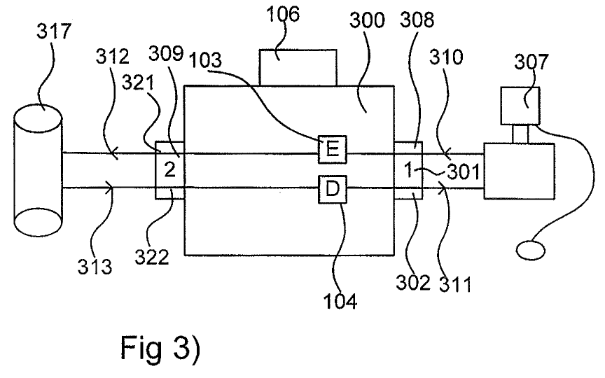

FIG. 3 shows a data encryption system 300 comprising a data encryption unit 330 and an external device 307 similar to that shown in FIG. 2, but with an additional external device 317 connected to an additional second connector 309 separated from a first connector 308. The first connector 308 has a first 301 and a second 302 port, and the second connector 309 has a third 321 and fourth port 322. Arrows 310, 311, 312, and 313 indicate direction of data transfer. Arrows 310 and 311 indicate transmission of non-encrypted data, and arrows 312, and 313 indicates transmission of encrypted data. The first connector is preferably a male socket for connection with a female socket, for instance of USB type. The second connector is preferably a female socket for connection with a male socket, allowing the data encryption device to act in host mode for external devices connected to the second connector. The wording host mode is in this connection to be construed as a communications mode that allows a device such as a computer to respond to an incoming signal and receive data without human assistance.

The data encryption device according to FIG. 3 is arranged to receive a file to be encrypted on a first port 301 of a first connector 308, encrypt it and transmit it via the third port 321 of the second connector 309 to an external device 307 such as an external storage media. The encrypted data may further be retrieved from the external device 307 via the fourth port 322 on the second connector 309, decrypted it and transmit it on the second port 302 of the first connector 308.

Hence, by using built-in encryption engine software, the encryption device can be used as a separate, stand-alone on-the-fly encryption device.

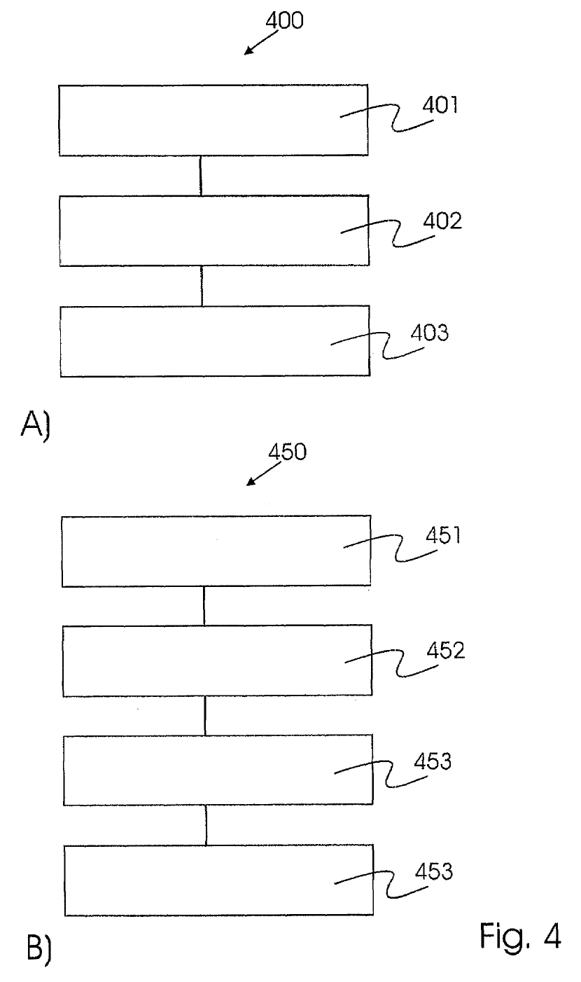

FIG. 4a) is a flow chart 400 illustrating the steps of a method according to the invention in which an encryption unit in an encryption device receives 401 an authentication signal from an authentication unit, encrypted data is received 402 on a first port of the device, and transferring 403 the encrypted data to an internal memory of the device.

FIG. 4b) is a flow chart 450 illustrating the steps of a method implemented in a device according to the invention in which an authentication signal is received 451 from an authentication unit of the device, data received 452 from a first port is encrypted 453 and transferred 454 to a second port of the device.

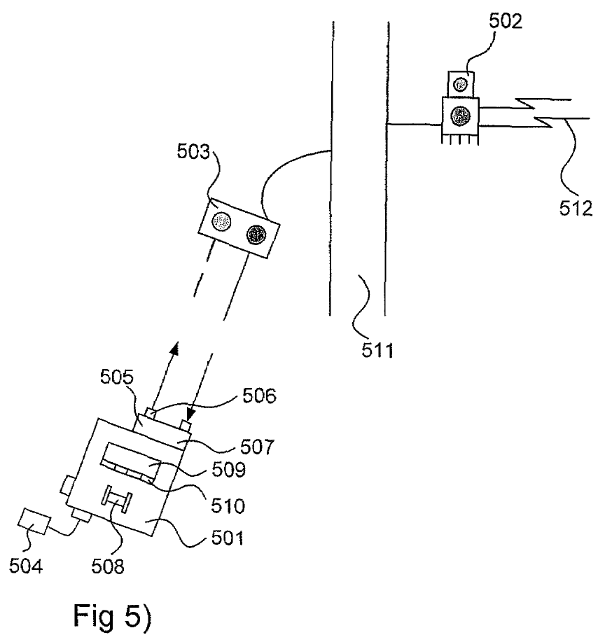

FIG. 5 illustrates schematically the device utilized for secure authorization to allow access to restricted environments. In the figure it is shown a secure encryption device 501 according to one embodiment of the invention, a control means 502, a communication unit 503 connected to the control device 502 and, an external device 504 connected to the device 501. Indicated on the device 501 is communication means 505 having ports 506 and 507, an authorization unit 508 for fingerprint scanning, a display 509 and input means 510. Also indicated in the figure is a door 511 and a connection of the control device 502 to a network 512.

Furthermore, the device can also act as a key with a high level of security due to its inherited encryption and decryption capabilities together with the authorization means. For instance, entrances in a building, such as doors, can be equipped with locking means having locking mechanisms which mechanism is controlled by control means. The control means can be arranged to communicate with a device according to the present invention. The device may hold a pieces of information associated with corresponding counterpart information of each of the control means. With the encryption and decryption capabilities of the device, these pieces of information can be exchanged securely, and a user can be allowed access to any part of a building. Also, any number of keys or users can be stored in the device, depending on the size of the memory storage of the device. With an extension slot, the device can also handle additional storage modules such as memory cards. Advantageously, the device communicates wirelessly, for instance via IR or Bluetooth, allowing a user to authenticate from a distance when approaching an entrance to be opened.

For instance, a sequence wherein a user of a device gains access to a certain area by opening a door may for instance comprise the following steps:
A signal for initiating contact with control means controlling access through a door is emitted from a device.
The signal is received by the control means and an opening sequence is initiated. Hence, if a correct opening code is received by the control means within a predetermined time interval, i.e. two minutes, the control means initiates door opening.
The control means signals a control code.
The device encrypts the control code and returns the encrypted control code to the control means.
The control means verifies the encrypted control code, and if correct, initiates door opening.
In the case where the returned control code is incorrect, the control means initiates a delay sequence, making the control means inaccessible for a predetermined time interval. Hence, as an advantage, it minimizes the risk of repeated attempts from trespassers trying guess the correct code or attempting to overload the control means.

The device may be equipped with a display and means for receiving input from a user. Hence, a user can be view a list of access points leading to areas which the user is allowed access to. When reaching a door, the user can either select from a list or automatically be presented the item corresponding to the door. The user then selects it and initiates the procedure, covered by the steps in the previous paragraph. Advantageously, the device can also be an integrated component of a communication terminal such as a mobile phone. Hence, separate keys are no longer necessary. It may be especially advantageous in that many components of the device and a communication terminal are common such as a display, input means, battery, memory etc.

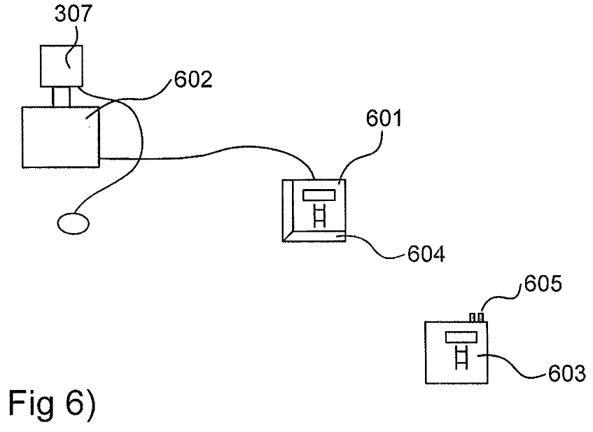

FIG. 6 shows schematically a secure encryption device 601 according to the invention, a terminal 602, and an administration device 603. The encryption device 601 and administration device 603 are further shown with communication means 604 and 605.

1. A data encryption device comprising:
a first and a second port adapted to communicate data from at least one external unit,
an encryption unit connected to the first port,
an internal memory connected to the encryption unit,
a decryption unit connected to the internal memory and to the second port, and
an authentication unit connected to the encryption unit and the decryption unit, the authentication unit being adapted to provide an authentication signal in response to a valid authentication of a user,
wherein the encryption unit is adapted to receive an authentication signal from the authentication unit and in response to a receipt of the authentication signal encrypt data received from the first port and transfer the encrypted data to the internal memory, and the decryption unit is adapted to receive an authentication signal from the authentication unit and in response to a receipt of the authentication signal decrypt data received from the internal memory and transfer the decrypted data to the second port.

2. A data encryption device comprising:
a first and a second port adapted to communicate data from at least one external unit,
an encryption unit connected to the first port and the second port,
a decryption unit connected to the first port and the second port,
an authentication unit connected to the encryption unit and the decryption unit, the authentication unit being adapted to provide an authentication signal in response to a valid authentication of a user,
wherein the encryption unit is adapted to receive an authentication signal from the authentication unit and in response to a receipt of the authentication signal encrypt data received from the first port and transfer the encrypted data to the second port, and the decryption unit is adapted to receive an authentication signal from the authentication unit and in response to a receipt of the authentication signal decrypt data received from the second port and transfer the encrypted data to the first port.

3. The data encryption device according to any of claim 1 wherein the encryption unit is adapted to internally to the encryption device encrypt received data.

4. The data encryption device according to claim 2 wherein the encryption unit is adapted to internally to the encryption device encrypt received data.

5. A system comprising a data encryption device according to claim 2 and wherein the second port is further connected to an external unit.

6. The data encryption device according to claim 1, wherein the encryption and decryption are in the form of a single unit.

7. The data encryption device according to claim 2, wherein the encryption and decryption are in the form of a single unit.

8. The data encryption device according to claim 1, wherein the authentication unit comprises a biometric sensor.

9. The data encryption device according to claim 2, wherein the authentication unit comprises a biometric sensor.

10. The data encryption device according to claim 8, wherein the biometric sensor is adapted to recognize/sense voice, finger print, retinal, ear acoustics, or any combinations thereof.

11. The data encryption device according to claim 9, wherein the biometric sensor is adapted to recognize/sense voice, finger print, retinal, ear acoustics, or any combinations thereof.

12. The data encryption device according to claim 1, wherein the external unit comprises a computing device, a terminal, a server, a remote storage, a hard drive storage, a flash memory, or any combinations thereof.

13. The data encryption device according to claim 2, wherein the external unit comprises a computing device, a terminal, a server, a remote storage, a hard drive storage, a flash memory, or any combinations thereof.

14. The data encryption device according to claim 1, wherein any of the first and second ports comprise wireless connections.

15. The data encryption device according to claim 2, wherein any of the first and second ports comprise wireless connections.

16. The data encryption device according to claim 1, wherein the first and second port are one and the same port.

17. The data encryption device according to claim 2, wherein the first and second port are one and the same port.

18. The data encryption device according to claim 1, wherein the device further comprises a switching device for determining whether the data received from the first port comprises encrypted or decrypted information and the switching device is arranged to direct the received data to the encryption unit or decryption unit.

19. The data encryption device according to claim 2, wherein the device further comprises a switching device for determining whether the data received from the first port comprises encrypted or decrypted information and the switching device is arranged to direct the received data to the encryption unit or decryption unit.

20. The data encryption device according to claim 18, wherein the determining is done by recognizing information in a header of the received data, by receiving an indication induced by a user acting on a physical switch in connection with the encryption device or in response to a command provided by the user.

21. The data encryption device according to claim 19, wherein the determining is done by recognizing information in a header of the received data, by receiving an indication induced by a user acting on a physical switch in connection with the encryption device or in response to a command provided by the user.

22. A method for data encryption in an encryption device, comprising:
receiving an authentication signal from an authentication unit;
encrypting data received from a first port of the device; and
transferring the encrypted data to a memory of the device.

23. A method for data encryption in an encryption device comprising:
receiving an authentication signal from an authentication unit;
encrypting data received from a first port of the device; and
transferring the encrypted data to a second port of the device.

24. The method claim according to claim 23, wherein the decryption unit is adapted to encrypt data internally of the encryption device.

25. The method claim according to claim 24, wherein the decryption unit is adapted to encrypt data internally of the encryption device.

26. The device according to claim 1, wherein the device is arranged to hold authentication information of at least a first and a second user.

27. The device according to claim 2, wherein the device is arranged to hold authentication information of at least a first and a second user.

28. The system according to claim 5, wherein the device is arranged to hold authentication information of at least a first and a second user.

29. The system according to claim 5, wherein the device is arranged to hold at least a first key of at least a first key-pair, and said external device is arranged to hold at least a second key of said first key-pair.

30. The system according to claim 5, the external device comprising control means for controlling access to a designated area.
